(19) United States
(12) Patent Application Publication
(10) Pub. No.: US 2010/0068357 A1
(43) Pub. Date: Mar. 18, 2010

(54) Pork Systems and Methods

(75) Inventor: Matt Osborn, Eureka, KS (US)

Correspondence Address: CARGILL, INCORPORATED, P.O. Box 5624, MINNEAPOLIS, MN, 55440-5624, US

(73) Assignee: CARGILL, INCORPORATED, Minneapolis, MN (US)

(21) Appl. No.: 12/225,748

(22) PCT Filed: Mar. 28, 2007
(86) PCT No.: PCT/US2007/065317

§ 371 Date: Sep. 9, 2009

Related U.S. Application Data
(60) Provisional application No. 60/786,932, filed on Mar. 28, 2006.

(51) Int. Cl. A23B 4/28; A23B 4/044; A23L 3/18; A23L 3/3454

(52) U.S. Cl. 426/266; 99/470; 99/483; 99/532; 99/535

(57) ABSTRACT

A continuous method and system for curing, smoking and chilling pork bellies for use in bacon processing operations. The pork bellies are carried through each stage on a continuous conveyor system on a first-in first out basis. In one embodiment, the pork bellies are secured to the conveyor system to fix or maintain at least one dimension of the pork bellies during smoking and/or chilling.

### FIELD OF THE INVENTION

This invention relates to pork processing systems and methods. More particularly, the invention relates to methods and systems for processing raw pork bellies into a sliced pork product such as bacon.

### BACKGROUND

Bacon is traditionally processed from pork bellies as part of a batch-wise operation. FIG. 1 is a flow chart illustrating a traditional batch-wise method 10. The pork bellies are first cured to enhance the flavor of the pork belly meat and to reduce spoilage (Block 12). Curing involves dispersing a pickling solution throughout the pork belly. Conventional pickling solutions include water and salt, either alone or in combination with sodium or potassium nitrite, polyphosphates and/or various flavorings. The pickle solution is pumped directly into the raw or “green” pork belly under pressure to increase the weight of the belly by between about 8% and 15% of the belly's green weight. Dry curing processes can also be employed.

A batch of the cured pork bellies are then transported to one or more enclosed smokehouses and are hung from meat combs or hangers, which in turn, are hung from trees, racks or cages. The batch of hung pork bellies are then “smoked” by applying heat and/or smoke-laden currents of air in the smokehouse to add flavor, preserve and/or reduce the water content of the meat (Block 14). Generally, the smoking temperature for bacon is less than about 160 degrees Fahrenheit and is designed to raise the internal temperature of bellies to around 126 degrees Fahrenheit. The smoking step is complete when the moisture content has been stabilized at a level that provides a smoked and chilled weight below about 103% of the green weight. This ordinarily requires minimum smoking time ranging from about 6 to about 8 hours, although smoking for much longer periods of time is not uncommon. Liquid smoke can also be applied to pork bellies.

After smoking, the batch of pork bellies, which are generally still suspended from hangers, are transported to and stored in a refrigeration unit to reduce the temperature of the pork bellies from about 128 degrees Fahrenheit to about 15 degrees Fahrenheit (Block 16). Batch-wise chilling in this manner may take up to 24 hours or more.

After chilling, the pork bellies are optionally stored before being trimmed and sliced (Block 18). The trimming process often yields meat trimmings, which may be processed into finished products such as bacon toppings. Slicing is carried out via automatic slicing apparatuses. Bacon slices and other trimmings which do not fall within a predetermined length, width, and/or thickness are either discarded or processed separately into additional lower-cost meat products.

Overall, the aforementioned bacon processing method takes 24 hours or more to complete. Although the traditional batch-wise method for processing bacon from pork bellies produces a quality product, it produces significant inefficiencies in a commercial setting related to processing time, floor space, energy input (particularly during heating and chilling), inventory requirements and labor.

### SUMMARY OF THE INVENTION

The present invention provides systems and methods for processing pork portions. One embodiment is a method for processing a pork portion into bacon slices. The pork portion is placed on and secured to a continuous conveyor system that conveys the pork portion through a curing station, smoking station and chilling station. The pork portion is secured to the continuous conveyor system such that at least one dimension of the pork portion is substantially maintained when heated. The pork belly is then sliced to form bacon slices. In certain embodiments, at least one dimension of the pork belly may be modified before being secured to the conveyor system. For example, a force may be applied to the pork belly to increase its width or length. This increased dimension may then be maintained when the pork belly is secured to the conveyor system and heated.

In another embodiment, the present invention is a continuous method for processing a plurality of pork portions, in which the pork portions are arranged on a continuous conveyor system that conveys the pork portions through a curing and/or heating station on a first-in first-out basis. Prior to heating, at least one dimension of the pork portions may be maintained and/or modified such that the portions have at least one substantially uniform dimension.

In a further embodiment, the present invention is a continuous system for processing pork portions, which includes a curing station, a smoking station, a chilling station and a continuous conveyor system configured to convey the pork portions through each station. The conveyor system also includes means for fixing at least one dimension of the pork portions, means for increasing at least one dimension of the pork portions and/or means for reducing at least one dimension of the pork portions.

### BRIEF DESCRIPTION OF THE DRAWINGS

FIG. 1 is a flow-chart illustrating a traditional batch-wise bacon processing method.

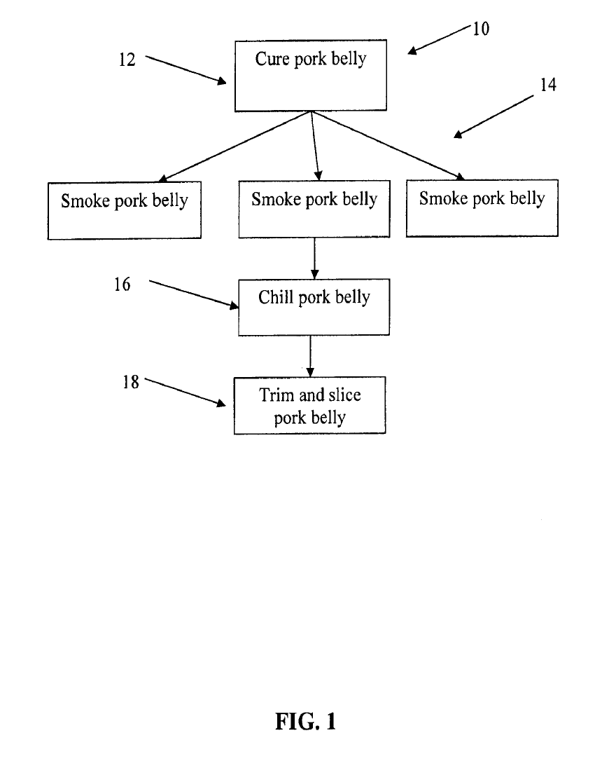

FIG. 2 is a flow-chart illustrating a bacon processing method according to one embodiment of the present invention.

### DETAILED DESCRIPTION

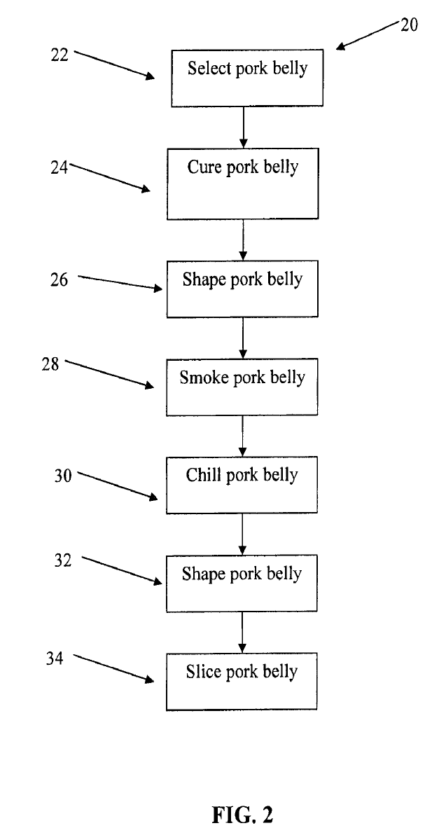

FIG. 2 is a flow-chart illustrating a continuous bacon processing method 20 according to one embodiment of the present invention. The method 20 includes the steps of selecting pork bellies (step 22), curing the pork bellies (step 24), shaping the pork bellies (step 26), smoking the pork bellies (step 28), chilling the pork bellies (step 30) trimming the pork bellies (step 32) and slicing the pork bellies (step 34). Although the method is directed to processing pork bellies, similar processing steps could be used on other pork portions or meat portions in a similar manner.

### Select Pork Bellies (22)

The pork bellies are removed from pig carcasses in a conventional manner, and are then measured for length, width and thickness. Similarly dimensioned pork bellies may be processed together to reduce waste trim caused by applying standardized shaping and slicing procedures to differently dimensioned pork bellies.

The pork bellies are then placed on a continuous conveyor system and are advanced to a curing station. Suitable continuous conveyor systems include horizontal conveyors and similar conveyor systems that carry the pork bellies between and/or through at least some of the processing steps set forth below on a generally continuous first-in first-out basis with minimal stoppage time. In one embodiment, the continuous conveyor system is a horizontal belt conveyor system in which the pork bellies are placed and carried on one or more generally flat surfaces, as opposed to being hung from hangers as used in traditional processes. Suitable continuous conveyor systems are generally known and can be modified to be compatible with the various processing stations described below. In another embodiment, multiple continuous conveyors may be employed to convey pork bellies to multiple curing, smoking and/or chilling stations.

### Cure Pork Bellies (24)

The pork bellies are cured by injecting a sufficient pickling solution into the pork bellies under suitable conditions to disperse the pickling solution throughout the pork bellies, and to raise the weight of each pork belly to between about 103% and 115% of its green weight. In one embodiment, the pork bellies are injected with a pickling solution using an automated pressurized injection system as the pork bellies are conveyed along the continuous conveyor system. Suitable injection systems of this type are sold under the brand name Imax by Schröder Maschinenbau KG, Germany.

### Shape Pork Bellies (26)

Optionally, the pork bellies may be shaped prior to smoking to produce pork bellies and bacon slices having more desirable and/or uniform dimensions. Shaping can be carried out in various ways. In one embodiment, shaping is accomplished by securing the pork belly to the continuous conveyor system in a manner that substantially fixes or maintains at least one dimension (e.g., length, width and/or thickness) of the pork belly during the curing, smoking and/or chilling processes. In embodiments in which a horizontal conveyor is used, one or more sides or ends of the belly can be secured to the conveyor via combs, clips, clamps or any other securement means (referred to herein as “clamps”) to fix the length or width of the bellies. For example, the ends of the belly can be secured to clamps located on opposing sides of the horizontal conveyor fix the length of the pork belly during subsequent processing. In another example, the bellies could be secured to racks that are then placed on the conveyor. One benefit to fixing or maintaining a dimension of the pork belly in this manner is that shrinkage that occurs when the pork belly is heated is substantially reduced along at least one dimension.

In another embodiment, at least one dimension of the pork bellies is increased by applying a lengthwise or widthwise force to one or more ends or sides of the pork bellies. The force can be applied, for example, by pulling the ends or sides of the pork bellies using manual, semi-automated or fully automated processes, to stretch the pork bellies. By applying a lengthwise force to the pork bellies, their length can be increased by up to about 8 in., more particularly, between about 2 and about 6 in., and even more particularly, about 4 in. Lengthwise stretching may also cause the width of the pork bellies to be reduced to a lesser degree. One benefit to stretching the pork bellies in this manner is that the amount of trimming required to obtain pork bellies having substantially uniform dimensions may be reduced.

In a further embodiment, the pork bellies are first stretched as described above and are then secured to the conveyor to fix and/or maintain the stretched shape. For example, the pork bellies can be stretched lengthwise and then secured to the conveyor system such that the length of the belly extends generally across the width of the belt between opposing clamps. In this embodiment, reduced lengthwise shrinkage may provide a more uniform length, and/or reduced widthwise trimming may be accomplished.

In additional embodiments, at least one dimension of the pork bellies may be maintained or even reduced by, for example, pressing, molding or trimming prior to smoking.

### Smoke Pork Bellies (28)

The pork bellies may be smoked by applying heat and natural smoke, liquid smoke, or both, while the pork bellies are conveyed along the continuous conveyor system. In one embodiment, the pork bellies are heated in a continuous conveyor heating system, such as a spiral or linear impingement heating system, or another continuous conveyor heating system that operates on a first-in first-out basis.

Suitable continuous heating systems are capable of raising the internal temperature of the pork belly to between about 100 and 160 degrees Fahrenheit, more particularly between about 120 and 140 degrees Fahrenheit, even more particularly between about 125 and 130 degrees Fahrenheit. In certain embodiments, such continuous heating systems can raise the internal temperature of the pork bellies the amount in less than 5 hours, more particularly, in less than 3 hours, and even more particularly, in about an hour or less. Traditional smoking operations, in contrast, may take 5 or more hours to properly heat the pork bellies.

In a particular embodiment, a linear impingement heating system is used to expose the pork bellies to a current of hot gasses in a long, straight tunnel as the pork bellies are carried by the continuous conveyor system. Such linear systems may be capable of heating the pork bellies to the desired internal temperature in about one hour or less, and operate on a first-in first-out basis. Suitable impingement heating systems are available, for example, from FMC Technologies, Inc. Heating the pork bellies for a shorter period of time as compared to batch-wise smoking not only reduces overall processing time, but may also inhibit bacterial growth.

In order to impart a smoky flavor, the pork bellies may be subjected to liquid and/or natural smoke treatments before, during or after the heating operation described above. In one embodiment, liquid smoke is applied just prior to entering the continuous heating systems, and natural smoke is applied during or after heating the pork bellies in the continuous heating system. Methods of applying liquid and/or natural smoke are generally known in the art.

After heating, the internal temperature of the pork bellies may be reduced under generally ambient temperature conditions in order to more slowly reduce the temperature of the pork bellies prior to chilling.

### Chill Pork Bellies (30)

After smoking, the pork bellies are chilled to an internal temperature below the freezing point of water, and more particularly to between about 20 and 25 degrees Fahrenheit. In one embodiment, the pork bellies are advanced through a continuous spiral or linear impingement chilling system or other continuous chilling system to chill the pork bellies on a first-in first-out basis. Impingement chilling systems expose food products such as pork bellies to blasts of extremely cold gasses to surface freeze or “crust freeze” the food product. Impingement chilling systems may reduce the chilling time of a pork belly to as little as about 1 hour. Conventional chilling systems, in contrast, require 20 or more hours to chill.

Suitable linear systems of this variety include the Ross BLC II Impingement Tunnel Freezer available from Ross Company. Spiral impingement chilling systems are space-saving chilling units that transport food products such as pork bellies along a vertically-oriented spiral continuous conveyor system while subjecting the pork bellies to circulating cold gasses. Because the food products are chilled along a non-linear, vertically-oriented path, spiral chilling systems take up less floor space than traditional chilling units, while providing a continuous chilling operation. Suitable spiral chilling systems are sold by FMC Food Technologies, Chicago, Ill.

After chilling, the pork bellies may be tempered for a period of time (e.g., 3 to 4 hours) to allow the internal and external temperature of the pork bellies to equilibrate. In the continuous conveyor system described herein, the temperature of the pork bellies may be allowed to equilibrate while being transported from the chilling station to the slicing station without requiring additional storage space. Alternatively, the pork bellies may be palletized and stored for a sufficient period of time to reach temperature equilibrium.

### Trim Pork Bellies (32)

Prior to slicing, the pork bellies may be further trimmed, molded and/or pressed to remove less desirable portions of the belly and/or to provide additional dimensional uniformity. In one embodiment, the bellies are trimmed shortly after crust freezing as described above (or any other partial freezing process) such that an outer layer of the pork bellies have a significantly lower temperature than the elevated internal temperature of the pork bellies. In another embodiment, the pork bellies are trimmed after reaching temperature equilibrium. One benefit to performing a preliminary external freeze prior to shaping is that the pork bellies have increased rigidity to reduce shape loss during subsequent processing steps while still being easier to shape than fully chilled pork bellies. Additionally, a crust freeze may inhibit bacterial growth on the pork bellies after smoking.

In an alternate embodiment, the smoked pork bellies are trimmed, pressed or molded shortly after exiting the smoking station while the bellies are still at an elevated temperature. For example, the pork bellies may have an internal temperature greater than the temperature of the surrounding processing environment, more particularly a temperature of at least about 100 degrees Fahrenheit, and even more particularly a temperature between about 100 degrees Fahrenheit and about 160 degrees Fahrenheit. Pork trimmings produced during shaping are collected prior to chilling the pork bellies and are transported to a separate processing area. By separating trimmings from the pork bellies prior to chilling, less energy is required to chill the pork bellies.

A variety of approaches can be taken to trim the pork bellies. In one embodiment, the pork bellies are advanced along the continuous conveyor system through a cutting station that includes a stationary set of opposing blades on each side of the conveyor that trim the sides or ends of the pork bellies as they are carried by the conveyor. If trimming of both the ends and sides is desired, the pork bellies can be shifted 90 degrees on the conveyor system and carried through a second set of opposing blades. In this embodiment, the bellies may be turned along a single conveyor or can be transferred to an intersecting conveyor, which contains the second set of opposing blades.

Suitable blades include articulating blades such as circular saw blades and bandsaw blades, as well as stationary knife blades. Other meat cutting devices known to trim raw meat may also be suitable. In one embodiment, the distances between the opposing blades is adjustable depending on the desired dimensions of the trimmed pork bellies. If the pork bellies are grouped together by size or are shaped prior to smoking, the blades may be adjusted periodically depending on the size grouping.

In addition to or as an alternative to trimming the sides and/or ends, the pork bellies may also be molded or pressed prior to slicing on a continuous basis using, for example, rollers or presses secured to the conveyor system. In embodiments which utilize the preliminary crust freeze described above, molding may take place during freezing. For example, an impingement freezer could be modified with rails, presses or the like on each side of the conveyor, and/or elevated above the conveyor to provide pork bellies with at least one substantially uniform dimension. Such devices could also be employed any time after chilling and before slicing.

### Slicing and Packaging the Pork Bellies (34)

The chilled pork bellies may be sliced into bacon by a conventional slicing apparatus. The resulting bacon slices may be packaged and sold as is or may be subjected to a partial or complete cooking step to form precooked bacon slices prior to distribution. Pork trimmings obtained during this processing method may be processed into finished goods such as bacon toppings.

Several benefits over batch-wise pork processing can be accomplished by embodiments of the present invention. Notably, pork products formed from the methods described herein can be produced at a significant time savings compared to conventional batch-wise methods. For example, embodiments of the present invention can reduce processing time from over 24 hours to less than ten hours, more particularly to 8 hours or less. Additionally, manual labor required to hang, remove, trim and mold pork bellies can be reduced or eliminated. This reduction in physical handling may also reduce the likelihood of cross-contamination of pork bellies. Pork belly inventory can also be reduced by the present invention.

1. A continuous method for processing a pork portion into bacon slices, comprising:
placing the pork portion on a continuous conveyor system that conveys the pork portion through a curing station, a smoking station and a chilling station;
curing the pork portion at the curing station;
heating the pork portion at the smoking station;
chilling the pork portion at the chilling station; and
slicing the pork portion to form bacon slices
wherein at least first and second ends of the pork portion are secured to the conveyor system to maintain a width dimension, a length dimension or both dimensions of the pork portion during heating; and
further comprising the step of applying a stretching force along the length or width dimension and securing the pork portion to the continuous conveyor system such that the stretched dimension is maintained.

2-4. (canceled)

5. The method of claim 1 wherein the continuous conveyor system comprises a substantially horizontal conveyor belt.

6. (canceled)

7. The method of claim 5 wherein first and second ends of the pork portion are secured to opposing sides of the horizontal conveyor belt to maintain a length dimension of the pork portion.

8. The method of claim 1 wherein the heating step comprises heating the pork portion for less than 5 hours on a first-in first-out basis.

9. The method of claim 1 further including the step of applying smoke to the pork portion at the smoking station.

10. The method of claim 1 wherein the chilling step includes the step of surface freezing the smoked pork portion in less than about one hour on a first-in first-out basis.

11. The method of claim 1 further comprising the step of trimming the pork portion after chilling.

12. The method of claim 11 wherein the trimming step comprises reducing a length dimension, a width dimension or both.

13. The method of claim 11 wherein the trimming step comprises reducing a thickness dimension of the pork portion.

14. The method of claim 1 wherein
the heating and applying smoke to the pork portions at the smoking station is carried out on a substantially first-in first-out basis.

15-18. (canceled)

19. A continuous system for processing pork portions comprising:
a curing station configured to inject a pickling solution into a plurality of pork portions on a continuous basis;
a smoking station configured to raise the internal temperature of a plurality of pork portions and to apply smoke to the pork portions on a continuous basis;
a chilling station configured to decrease the internal temperature of a plurality of pork portions on a continuous basis; and
a continuous conveyor system configured to convey pork portions up to and through the curing station, smoking station and chilling station, the continuous conveyor system further including means for applying a stretching force along the length or width dimension and securing the pork portion to the continuous conveyor system such that the stretched dimension is maintained.

20. The system of claim 19 wherein the smoking station includes an impingement oven.

21. The system of claim 19 wherein the chilling station includes an impingement chiller

22. The system of claim 19 wherein the means for applying a stretching force includes at least one clamp for securing the pork portions to the conveyor system.

23. The system of claim 24 wherein the means for reducing includes at least one blade that is stationary mounted relative to the conveyor system.

24. The system of claim 19 wherein the conveyor system further includes means for reducing at least one dimension of the pork portions.

25. A continuous system for processing pork portions comprising:
a curing station configured to inject a pickling solution into a plurality of pork portions on a continuous basis;
a smoking station configured to raise the internal temperature of a plurality of pork portions and to apply smoke to the pork portions on a continuous basis;
a chilling station configured to decrease the internal temperature of a plurality of pork portions on a continuous basis; and
a continuous conveyor system configured to convey pork portions up to and through the curing station, smoking station and chilling station, the continuous conveyor system further comprising clamps located on the conveyor system to fix the pork portion to the continuous conveyor system such that a stretched dimension of the pork portion can be maintained.

26. The system of claim 25 wherein the smoking station includes an impingement oven.

27. The system of claim 25 wherein the chilling station includes an impingement chiller

28. The system of claim 25 wherein the conveyor system further includes means for reducing at least one dimension of the pork portions.

29. The system of claim 28 wherein the means for reducing includes at least one blade that is stationary mounted relative to the conveyor system.

30. The method of claim 10 further comprising the step of trimming the pork portion after surface freezing.
